(19) United States
(12) Patent Application Publication
(10) Pub. No.: US 2013/0329055 A1
(43) Pub. Date: Dec. 12, 2013

(54) Camera System for Recording and Tracking Remote Moving Objects

(71) Applicants: Manfred Hiebl, Neuburg a.d. Donau (DE); Hans-Wolfgang Pongratz, Taufkirchen (DE)

(72) Inventors: Manfred Hiebl, Neuburg a.d. Donau (DE); Hans-Wolfgang Pongratz, Taufkirchen (DE)

(73) Assignee: EADS Deutschland GmbH, Ottobrunn (DE)

(21) Appl. No.: 13/983,422

(22) PCT Filed: Feb. 2, 2012
(86) PCT No.: PCT/DE2012/000085

§ 371 Date: Aug. 28, 2013

(30) Foreign Application Priority Data
Feb. 4, 2011 (DE) 10 2011 010 337.6

(51) Int. Cl. H04N 5/232

(52) U.S. Cl. CPC H04N 5/23296
USPC 348/169

(57) ABSTRACT

A camera system for detecting and tracking moving objects located at a great distance includes a camera having a camera lens system, and a position stabilizing device. The camera includes a first image sensor and a second image sensor. The camera lens system includes optical elements for focusing incident radiation onto a radiation sensitive surface of the first image sensor and/or the second image sensor with a reflecting telescope arrangement and a target tracking mirror arrangement, and a drive device for a movable element of the target tracking mirror arrangement and with a control system for the drive device. The optical elements includes a first subassembly of optical elements having a first focal length and associated with the first image sensor, and a second subassembly of optical elements having a second focal length that is shorter than the first focal length and associated with the second image sensor.

### TECHNICAL FIELD

Exemplary embodiments of the present invention relate to a camera system for detecting and tracking moving objects located at a great distance.

### BACKGROUND OF THE INVENTION

An important task of military reconnaissance work is to detect and identify missiles launched in enemy territory as well as to track the flight path of such missiles, so that the missile's target destination can be calculated from its flight path and defensive measures can be initiated against the missile. The (problem with such an approach is that this reconnaissance work can be performed only from a great distance, hence from outside the enemy territory.

A missile that is taking off has an engine jet stream that emits a light signal of more than 1,000,000 watts per square meter. Although this light signal can be detected from a great distance, it is available for detection for only a relatively short period of time, i.e. only during the combustion period of the engine. This period of time, however, is generally not long enough to track the flight path and, hence, to predict the target destination.

### SUMMARY OF THE INVENTION

Exemplary embodiments of the present invention are directed to a camera system that is able to monitor a missile taking off from a territory, even from a great distance, and is able to track its flight path and to make a prediction about the targeted destination.

In accordance with exemplary embodiments of the present invention, an inventive camera system for detecting and tracking moving objects located at a great distance comprises a camera, which is provided with a camera lens system, and a position stabilizing device for the camera and the camera lens system. The camera is provided with a first image sensor having a first high speed shutter, which is associated with this first image sensor, and a second image sensor having a second high speed shutter, which is associated with this second image sensor. The camera lens system comprises a device of optical elements for focusing incident radiation onto a radiation sensitive surface of the first image sensor and/or the second image sensor with at least one reflecting telescope arrangement and at least one target tracking mirror arrangement and is provided with a drive device for at least one movable element of the target tracking mirror arrangement and with a control system for the drive device. The device of optical elements comprises a first subassembly of optical elements having a first focal length, said first subassembly being associated with the first image sensor; and a second subassembly of optical elements having a second focal length that is shorter than the first focal length, said second subassembly being associated with the second image sensor.

In order to detect the light emitted by the engine jet stream of a missile taking off, this position stabilized camera is able to scan an Observation area with the image sensor associated with the shorter focal length by means of the element that is controlled by a control system and is moved by the drive device, for example, a target tracking mirror. On detection of an object, an enlarged image of the detected object can be obtained by means of the first image sensor associated with the longer focal length. This process makes it easier to identify the object.

For this purpose, the optical beam path is preferably designed in such a way that it can be switched between the first subassembly and the second subassembly. For this switch-over there is preferably a movable, in particular pivotable, mirror.

Preferably the image sensor has a sensitivity maximum in the spectral range between 0.7 μm and 1.7 μm wavelength. In this wavelength range, all rocket propellants that are currently known emit during bum-off a reliable, stable signal of about 1,000,000 watts per square meter. Furthermore, the earth's atmosphere has, in this wavelength range, a window with a high light transmission above an altitude of 15 km, thus enabling high visibility in this spectral range.

In a preferred embodiment the image sensor comprises an indium gallium arsenide CCD sensor chip that is preferably uncooled. Such a sensor chip is particularly sensitive in the spectral range between 0.7 μm and 1.7 μm and has a maximum sensitivity that is close to the theoretically possible sensitivity limit. It is particularly advantageous if this sensor chip has a high resolution.

Preferably the respective high speed shutter of the camera is designed in such a way that the corresponding image sensor can record a plurality of single frames in rapid sequence, preferably at a rate of 50 images per second, even more preferably 100 images per second. This rapid sequence of single frames enables the inventive camera to scan a large search volume, thus a large horizontal and vertical field of view, in rapid succession, so that the camera scans that are performed in this way ensure a high reliability for the detection of light-emitting moving objects.

It is especially advantageous if at least one of the subassemblies of optical elements comprises a set of Barlow lenses. Such a set of lenses makes it possible to achieve high light transmission and, therefore, a high sensitivity at a long focal length.

In an additional preferred embodiment the camera comprises a filter arrangement consisting of a plurality of spectral fitters, each of which can be coupled, as required, into the optical path. In this case the fitter arrangement is preferably designed as a filter wheel. Such a filter arrangement, in particular, such a rapidly rotating filter wheel with, for example, three band pass filters that cover the whole spectral range, can produce, after coupling into the optical path, sequentially false color ages of the moving object, for example, a burning rocket exhaust trail, which radiates light energy and thermal energy. In the event that the camera is at the same time a high resolution camera, with which it is possible to image the light source, thus, for example the rocket exhaust trail, on a plurality of pixels of the sensor, then the images contain enough shape, color and spectral information, in order to be able to make an identification of the object.

It is particularly advantageous, if furthermore, the camera system is provided with a target illuminating device that has a radiation. source, preferably a laser diode radiation source or a high pressure xenon short arc lamp radiation source. Using this target illuminating device, the object that has been detected can be identified, even if the object itself no longer emits light or more specifically thermal radiation or emits only a very low level of radiation, as is the case, for example, with a missile, for which the combustion period of the engine has ended. This target illuminating device, which is formed preferably by a near infrared laser diode target illuminating device or a near infrared high pressure xenon short arc lamp target illuminating device, illuminates the moving object that has been detected; and the camera receives the radiation of the target illuminating device that is reflected from the illuminated, moving object.

The target illuminating device can be coupled with the camera lens system in such a way that the target illumination radiation, emitted by the target illuminating device, can be coupled. into the optical path of the camera lens system, in order to focus the emitted radiation. Such a target illuminating device with a long focal length makes it possible to produce in the target range, i.e. in the area of the moving object, a light spot that has an area many times the size of the target object and that is so large that it illuminates the target object, yet still reflects enough light back to the image sensor of the camera system.

It is particularly advantageous if the camera lens system comprises a mirror arrangement for coupling the target illumination radiation. In this case the mirror arrangement is designed in such a way that the optical path of the camera lens system can be switched between the first image sensor and the target illuminating device in a time synchronous manner with the transmission of the illumination pulse and the arrival of its echo pulse. In this so called “gated view” operation, a radiation pulse, generated by the target illuminating device, is sent by the camera lens system onto the target, while the optical path to the corresponding image sensor is interrupted. In this case the cycle of this stroboscopic target illumination is selected in such a way that the duration of each illumination pulse sent to the target is less than the time required to travel the distance from the camera system to the target object and back. Preferably the duration of each illumination pulse sent to the target is at least 40%, in particular greater than 60%, of the time required to travel the distance from the camera system to the target object and back.

Preferably the radiation source of the target illuminating device is designed to emit pulsed light flashes, preferably in the infrared range. In this case the intensity of the near infrared light flashes is preferably at least 1 kW, even more preferably 2 kW. The energy pooling together with the high pulse power of ideally about 2 kW emits sufficient near infrared light to illuminate an object that is several hundred kilometers away, so that the light reflected by the object in this way is strong enough to be detected by the sensor of the camera.

Even more preferably the camera system is provided with an automatically operating image evaluating device, to which the image data of the images recorded by the camera are transmitted. With sufficient resolution of the received images, the automatically detected objects can be identified by means of this image evaluating device.

Preferred embodiments of the invention with additional configuration details and other advantages are described in detail and explained below with reference to the accompanying drawings.

### BRIEF DESCRIPTION OF THE DRAWINGS

The drawings show in

FIG. 1 a schematic representation of the optical configuration and optical paths of a camera system according to the invention; and

FIG. 2 a schematic representation of a target illuminating device of the camera system according to the invention.

### DESCRIPTION OF PREFERRED EXEMPLARY EMBODIMENTS

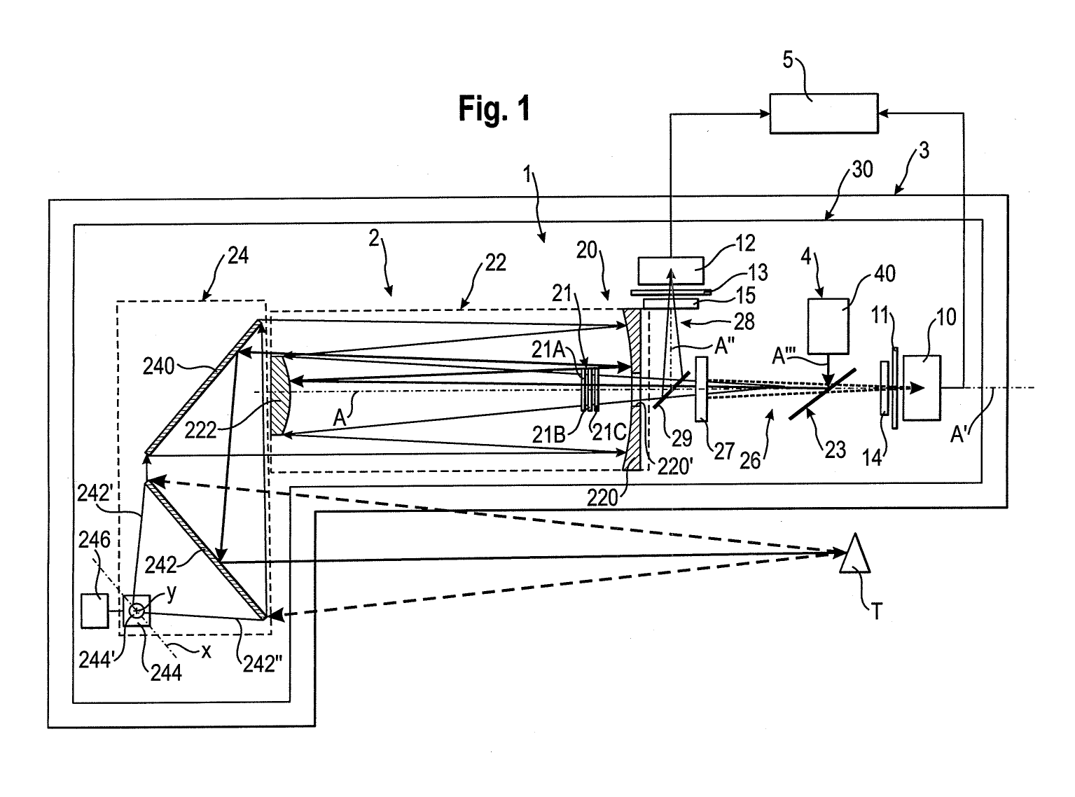

The camera system comprises a camera 1 provided with a camera lens system 2. The camera 1 is arranged on a platform 3. The platform 3 is equipped with a position stabilizing device 30 for the camera 1 and the camera lens system 2, which is also shown only in schematic form in FIG. 1.

The camera 1 comprises a first image sensor 10 with a high speed shutter 11. The first image sensor 10 is assigned a high frequency line of sight stabilization and image derotation unit 14. The first image sensor 10 has an optical axis A′, which corresponds to the optical axis A of the camera lens system 2.

A second image sensor 12 with its associated second high speed shutter 13 and a high frequency line of sight stabilization and image derotation unit 15 are arranged between the camera lens system 2 and the first image sensor 10 at an angle to the optical axis A of the camera lens system 2. In FIG. 1 the angle of the optical axis A of the camera lens system 2 is 90 degrees; and the angle of the optical axis A″, which is directed toward the second image sensor 12, is 90 degrees.

The two image sensors 10, 12 are sensitive the ear infrared range and are formed, for example, by an InGaAs CCD chip having a pixel size of preferably 30 μm and having a frame rate of up to 100 Hz. The sensors 10, 12 are preferably sensitive in the wavelength range of 0.90 μm to 1.70 μm and have a preferred image size of 250×320 pixels.

The camera lens system 2 comprises a device 20 of optical elements for focusing incoming radiation on the radiation sensitive surface of the image sensor 10 and/or the second image sensor 12. This optical device 20 is provided with a reflecting telescope arrangement 22, a target tracking mirror arrangement 24, a subassembly 26 of optical elements having a first focal length f1, the subassembly being associated with the first image sensor 10, and a second subassembly 28 of optical elements having a second focal length f2, said second subassembly being associated with the second image sensor 12. The second focal length f2 is shorter than the first focal length f1. The optical path of the first subassembly 26 has a fluorite flat field corrector (FFC) 27. In the preferred exemplary embodiment that is shown, the focal length f1 of the camera lens system 2 with the first subassembly 26, where the image captured by the camera lens system 2 is imaged on the first image sensor 10, is 38.1 m. The focal length f2 of the camera lens system 2 with the second subassembly 28, here the image captured by the camera lens system 2 is imaged on the second image sensor 12, is 2.54 m.

The reflecting telescope 22 in this exemplary embodiment is preferably formed by an aced Dall Kirkham or an infrared Ritchey Chretien telescope with a flat field corrector and has an aperture of 12.5″ (=31.75 cm). This telescope lends itself especially well to the near infrared range. The mirrors 220, 222 of the reflecting telescope are preferably provided with a gold surface reflection and, therefore, lend themselves especially well to use as infrared telescope mirrors.

The optical beam path of the camera lens system 2 with its optical axis A can be switched over by means of a switchable, preferably pivotable, mirror 29 between the optical beam path of the first subassembly 26 having the optical axis A′, directed towards the first image sensor 10, and the second optical subassembly 28 having the optical axis A″, which is directed towards the second image sensor 12. In this way the image captured by the camera lens system 2 can be imaged either on the first image sensor 10 or on the second image sensor 12.

The target tracking mirror arrangement 24, which is provided on the side of the reflecting telescope arrangement 22 that faces away from the image sensors 10, 12, comprises a first deflecting mirror 240, which is located in front of the reflecting telescope arrangement 22, as well as a movable second deflecting mirror 242. This second deflecting mirror 242 is mounted on a movable element 244′ of a drive device 244 by means of brackets 242′, 242″, which are shown only in schematic form in the figure, in such a way that the second deflecting minor 242 can be pivoted about a first axis x and a second axis y, which is located at right angles to this first axis, by means of the drive device 244, which is mounted on the platform 3. In order to control the drive device 244, there is a control system 246, which is shown only in schematic form in FIG. 1.

The reflecting telescope arrangement 22 includes a filter arrangement 21 having a plurality of spectral filters 21A, 21B, 21C. These filters can be coupled individually, as required, into the optical path, for which purpose the filter arrangement may be constructed as a filter wheel. The filters of the filter arrangement 21 are transmissive to different wavelength ranges in the total range from 0.90 μm to 1.70 μm, so that each filter, which acts as a blocking filter, can filter out a portion of the incident light from this wavelength range,

In the area of the first subassembly 26 a target illuminating device 4 is provided with a radiation source 40. The radiation source 40 is designed as a laser radiation source, preferably as a xenon flash illuminating device. The radiation source 40 emits light along an optical axis A′″, which extends transversely, preferably at right angles to the optical axis A of the camera lens system 2. In the area of the intersection of the optical axes A and A′″ there is a movable mirror arrangement 23, which consists of a rotating sector diaphragm in the illustrated example. The closed sector elements of the sector diaphragm are reflective in order to deflect the light emitted along the optical axis A′″ in the direction of the optical axis A of the camera lens system 2; and the open sector elements of the sector diaphragm allow light to pass from the camera lens system 2 to the first image sensor 10. In this way light from the target illuminating device 4 can be guided in an alternating fashion through the camera lens system 2 to a target T; and the light reflected from the target T can be guided back through the camera lens system 2 to the first image sensor 10, a process that will be described in detail below.

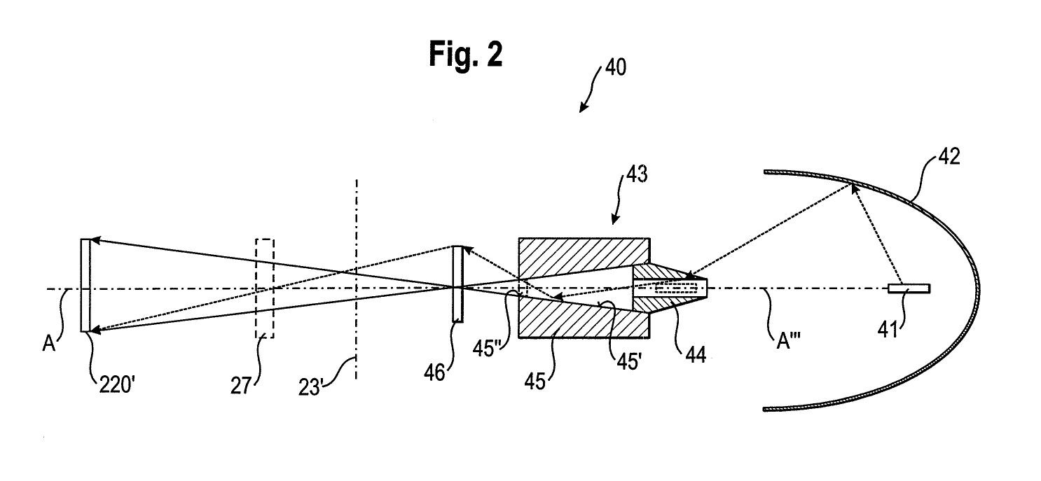

FIG. 2 shows an exemplary configuration of the radiation source 40 of the target illuminating device 4 that is shown only in symbolic form in FIG. 1. This radiation source 40 is equipped with a xenon short arc lamp and has, for example, an electrical power output of 12 kW and a radiation power in the near infrared range of 1,100 W.

An arc lamp 41 is arranged in an elliptical reflector 42; and this arc lamp generates a short arc that is about 14 mm long and 2.8 mm thick. The light emitted by this arc is guided from the elliptical reflector 42 to a condenser 43, which is provided with a sapphire glass hollow cone 44 as the condenser entry on the light entry side of said condenser and comprises a pinhole diaphragm block 45. The pinhole diaphragm block 45 has a light passage opening 45′ that tapers off from the light entry side to the light exit side and has an exit aperture 45″. The light passage opening 45′ has a polished gold surface. The pinhole diaphragm block 45 is liquid cooled. The sapphire glass hollow cone 44 is inserted, as shown in FIG. 2, with its light exit sided end in the light entry sided larger opening of the light passage opening 45′.

An illumination field lens 46 is arranged behind the pinhole diaphragm block 45 and images the exit aperture 45″ of the pinhole diaphragm block on the aperture 220′ of the reflecting telescope arrangement 22 (FIG. 1) by means of the fluoride flat field corrector 27. In order to simplify the drawing of the optical path in FIG. 2, the deflection of the optical axis A′″ of the radiation source 40 to the optical axis A of the reflecting telescope arrangement 22 by means of the mirror arrangement 23 in the area of the dashed-dotted line 23′ is not shown.

The operating principle of the camera system according to the invention will be explained below.

The camera 1 is aimed at a target area to be monitored with the activated second image sensor 12 and a deflecting mirror 29, which is swung into the optical path A of the reflecting telescope arrangement 22. Using a control computer (not shown) of a monitoring device, of which the camera system of the invention is an essential component, the control system 246 for the drive device 244 of the second deflecting mirror 242 is controlled in such a way that the second deflecting minor 242, which acts as the target tracking mirror, executes a search motion that scans line by line the target area. During this search motion, which scans the target area, the second image sensor 12 records images of the target area at a high frame rate of, for example, 100 Hz and passes these images to an image evaluating device 5 of the higher level monitoring device. During this recording process, one of the spectral filters 21A, 21B, 21C is pivoted, as required, alternatingly in rapid succession into the optical path of the reflecting telescope arrangement 22 so that each image of the target area that is recorded by the second image sensor 12 is exposed with one of the spectral filters 21A, 21B, 21C. The result is that a number of consecutive images, laid one on top of the other, produce a near infrared false color image of the target and simultaneously a multi-spectral analysis of the target area in the near infrared range. Then this false color image is passed to ⁻the image evaluating device 5 for evaluation, so that an automatic target detection and target identification may be carried out there, while at the same time false targets are recognized as such and can be removed from the relevant database.

If a target T is detected, the first image sensor 10 is activated. For this purpose the deflecting mirror 29 is swung out of the optical path A of the reflecting telescope arrangement 22, so that the light trapped by the reflecting telescope arrangement 22 can pass to the first image sensor 10. At the same time, a target tracking procedure is activated in the higher level control computer; and this procedure ensures that the deflecting mirror 242, acting as the target tracking mirror, is driven in such a way that it tracks the moving target T in such a way that the target T is always imaged on the first image sensor 10. The image sensor 10 also records the target T at a fast frame rate of 100 Hz, for example, and passes the image signals that are obtained to the image evaluating device 5, where an object identification of the target T is performed by means of the recorded image data.

If the target T ceases to perform its own radiation activity in the wavelength range, to which the camera 1 is sensitive (which is the case, for example, during cut-off of the engines of a missile (as the target T) that is taking off), then the target illuminating device 4 of the camera system according to the invention and the mirror arrangement 23 are activated in such a way that its sector diaphragm wheel begins to rotate. As a result, high energy radiation emitted by the radiation source 40 of the target illuminating device 4 is deflected at reflecting sector element of the mirror arrangement 23 and is directed into the optical path of the reflecting telescope arrangement 22 and is directed to the target 1 by means of the target tracking mirror arrangement 24. This high energy light flash is reflected from the target T and impinges back on the rotating sector diaphragm 23 by way of the target tracking minor arrangement 24 and the reflecting telescope arrangement 22, where at this point in time an open sector element may be found in the optical path, so that the light reflected from the target T can pass through the open sector diaphragm of the mirror arrangement 23 and can arrive at the first image sensor 10. Hence, the image sensor 10 may record images of the target T by means of the radiation emitted in a stroboscopic mode by the target illuminating device 4 by means of the rotating sector mirror arrangement 23, even if the target T is no longer emitting its own radiation.

This procedure allows the camera system according to the invention to detect and identify missiles taking off at a distance of up to 1,200 km and exhibiting a burning engine and, furthermore, to be able to track the missile on its path by means of the target illuminating device 4, which can be engaged and disengaged, even after the missile engine has cut off.

The reference numerals and symbols in the claims, the specification and the drawings serve only to facilitate a better understanding of the invention and are not intended to limit the scope.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE NUMERALS AND SYMBOLS

1 camera

2 camera lens system

3 platform

4 target illuminating device

5 image evaluating device

10 first image sensor

11 high speed shutter

12 second image sensor

13 high speed shutter

14 high frequency line of sight stabilization and image derotation unit

15 high frequency line of sight stabilization and image derotation unit

20 device

21 filter arrangement

21A spectral filter

21B spectral filter

21C spectral filter

22 reflecting telescope arrangement

23 mirror arrangement

23′ dash-dotted line

24 target tracking minor arrangement

26 first subassembly

27 fluorite flat field corrector

28 second subassembly

29 deflecting mirror

30 position stabilizing device

40 first radiation source

41 arc lamp

42 reflector

43 condenser

44 sapphire glass hollow cone

45 pinhole diaphragm block

45′ light passage opening

45″ exit aperture

46 illumination field lens

220 mirror

220′ aperture

222 mirror

240 first deflecting mirror

242 second deflecting mirror

242′ bracket for the deflecting mirror 242

242″ bracket for the deflecting mirror 242

244 drive device

244′ movable element of the drive device 244

246 control system

A optical axis

A′ optical axis

A″ optical axis

A″′ optical axis

T target

f1 first focal length f1

f2 second focal length f2

x first axis

y second axis

1-12. (canceled)

13. A camera system configured to detect and track moving objects located at a great distance, the camera system comprising:
a camera including a camera lens system; and
a position stabilizing device configured to stabilize the camera and the camera lens system,
wherein the camera comprises
a first image sensor having a first high speed shutter;
a second image sensor having a second high speed shutter;
wherein the camera lens system comprises a device of optical elements configured to focus incident radiation onto a radiation sensitive surface of the first image sensor or the second image sensor, the device of optical elements includes
at least one reflecting telescope arrangement;
at least one target tracking mirror arrangement;
a drive device for at least one movable element of the target tracking mirror arrangement; and
a control system for the drive device;
a first subassembly of optical elements having a first focal length, the first subassembly being associated with the first image sensor; and
a second subassembly of optical elements having a second focal length that is shorter than the first focal length, the second subassembly being associated with the second image sensor.

14. The camera system, as claimed in claim 13, further comprising:
a pivotable mirror configured to switch an optical beam path of the incident radiation between the first subassembly and the second subassembly.

15. The camera system, as claimed in claim 13, wherein the first or second image sensor has a sensitivity maximum in the spectral range between 0.7 μm and 1.7 μm wavelength.

16. The camera system, as claimed in claim 13, wherein the first or second image sensor comprises an uncooled indium gallium arsenide CCD sensor chip.

17. The camera system, as claimed in claim 13, wherein the first and second high speed shutters are configured in such a way that the corresponding image sensor can record a plurality of single frames in rapid sequence at a rate of at least 50 images per second.

18. The camera system, as claimed in claim 13, wherein the first and second high speed shutters are configured in such a way that the corresponding image sensor can record a plurality of single frames in rapid sequence at a rate of at least 100 images per second.

19. The camera system, as claimed in claim 13, wherein at least one of the first and second subassemblies of optical elements comprises a set of Barlow lenses.

20. The camera system, as claimed in claim 13, wherein the camera comprises a filter arrangement consisting of a plurality of spectral filters, each of which is coupleable, as required, into an optical path of the camera, wherein the filter arrangement is a filter wheel.

21. The camera system, as claimed in claim 20, wherein the filter arrangement is a filter wheel.

22. The camera system, as claimed in claim 13, further comprising:
a target illuminating device having a radiation source.

23. The camera system, as claimed in claim 22, wherein the radiation source is a laser diode.

24. The camera system, as claimed in claim 22, wherein the target illuminating device is coupleable with the camera lens system in such a way that the target illumination radiation emitted by the target illuminating device is coupleable into an optical path of the camera lens system, in order to focus the emitted radiation.

25. The camera system, as claimed in claim 24, wherein that the camera lens system comprises a mirror arrangement configured to couple the target illumination radiation, wherein the mirror arrangement is configured in such a way that the optical path of the camera lens system is switchable between the first image sensor and the target illuminating device in a time synchronous manner with the emission of the illumination pulse and with the arrival of its echo pulse.

26. The camera system, as claimed in claim 22, wherein the radiation source of the target illuminating device is configured to emit pulsed light flashes in an infrared range, wherein an intensity of the infrared light flashes is at least 1 kW.

27. The camera system, as claimed in claim 26, wherein the intensity of the near infrared light flashes is at least 2 kW.

28. The camera system, as claimed in claim 13, further comprising:
an automatically operating image evaluating device, to which image data of images recorded by the camera are transmitted.
